(19) United States
(12) Patent Application Publication
(10) Pub. No.: US 2005/0177491 A1
(43) Pub. Date: Aug. 11, 2005

(54) Real estate transaction method

(75) Inventors: Steve Siverson, Scottsdale, AZ (US); Daniel Thomas Marmo, Scottsdale, AZ (US)

Correspondence Address: ETHERTON LAW GROUP, LLC, 5555 E. VAN BUREN STREET, SUITE 100, PHOENIX, AZ, 85008, US

(73) Assignee: Marmco Properties, LLC

(21) Appl. No.: 11/053,980

(22) Filed: Feb. 8, 2005

Related U.S. Application Data
(60) Provisional application No. 60/543,375, filed on Feb. 9, 2004.

(51) Int. Cl. G06F 17/60

(52) U.S. Cl. 705/38

(57) ABSTRACT

The present invention is an improved business method that marries the real estate listing process with property improvement services to enable the property seller to sell an improved property without bearing the costs of the improvement. The real estate professional bears the initial financial burden of providing the home improvement service and is reimbursed by the property seller only upon sale of the home or cancellation of the listing.

### CROSS-REFERENCE TO RELATED APPLICATIONS

This application claims the benefit of co-pending provisional application No. 60/543,375 filed Feb. 9, 2004.

### BACKGROUND

This invention relates to methods of real estate transactions. This invention relates particularly to methods of listing real estate in conjunction with property-improvement services.

When selling a home, most homeowners contact a real estate agent to handle the transaction. Real estate agents usually are independent sales people who provide their services to a licensed real estate broker on a contract basis. In return, the broker pays the agent a portion of the commission earned from the agent's sale of the property. Brokers are independent businesspeople who sell real estate owned by others; they also may rent or manage properties for a fee. A license is required in every State and the District of Columbia to be a real estate broker or agent, however the owner of the real estate brokerage does not necessarily have to be licensed. Instead, a person or persons without a real estate license can form a brokerage and employ a licensed broker to do the work. Licensed agents and brokers and the brokerages that employ them are referred to collectively herein as “real estate professionals.”

The real estate agent is qualified to conduct a number of services as the property owner's agent, including preparing a description of the home, listing the home on a computerized database of homes for sale (referred to as a multiple-listing service or “MLS”), showing the home to potential homebuyers, and preparing documents related to the sale. Prior to listing the home, a real estate agent will require the seller to sign a contract that requires the seller to pay the agent a commission upon the sale of the home, the payment typically triggered by the sale of the home. In some states, the commission payment is triggered upon providing a “ready, willing and able” buyer or the like, regardless of whether the owner sells or refuses to sell. The agreement is known in the art as a “listing agreement.” This listing agreement is officially between the broker and the seller, although the real estate agent typically effects the execution of the agreement with the seller. That real estate agent is considered the “listing agent” and is typically specified as such on the listing agreement. The broker receives a sales commission when the property sells and pays a portion of it to the listing agent. A similar process is undertaken for commercial buildings, empty lots and other unimproved land. Collectively the real property and improvements thereon are referred to herein as the “property.”

By improving the appearance and condition of the property, the property will usually sell sooner and for a higher price. For example, a home that is well-landscaped presents better to a buyer, and therefore typically sells more quickly and for a higher price than one that is poorly landscaped. Similarly, an unfurnished home is more difficult to sell than one that is furnished. However, it is common for the homeowner to have moved her furniture out of the home, before the home is sold, for example, to move the furniture into the seller's new home. Or, in homes newly-built by property developers, the home might not be furnished before it is shown for sale. As another example, an unimproved lot in an area zoned for residential will sell for less than one that has utilities and roads installed.

In the high-end real estate market, it is known in the art to hire interior designers to furnish and decorate a home on behalf of a homeowner before putting the home up for sale. This process is referred to as “staging” a home. The interior designer is paid for the service of designing the decor as well as for the materials used to decorate the home. Conventionally the interior designer is paid upon completion of staging the home. This creates a heavy financial burden for the seller, however, who is often in the midst of financing a new home himself and who would prefer to preserve cash flow. Historically, staging has been used especially for new luxury homes offered by the home builder and for second homes of well-to-do buyers. However, a new type of real estate investing has become popular in which a person buys a home in a state of disrepair (a “fixer-upper”), quickly renovates and decorates the home, and then sells it after, hopefully, a very short period of time. This type of investment can be financially burdensome on the investor/owner for at least a short period of time, while significant cash is used to pay a down payment on the loan and to pay to renovate and decorate. Whether a high-end home or starter home, life-long owner or investor, it would be desirable to provide property-improvement services to the property owner to improve the salability of the property, without burdening the property owner with additional expenses. It would also be desirable to provide a solution in which the owner can improve the property prior to sale and reap the financial gain than to sell the property in a state of disrepair to an investor or other buyer who reaps the financial gain.

Banks and other financial institutions may lend money to the property seller for property improvement, but this places the financial burden on the seller just at the time he is trying to avoid additional financial burdens. Further, obtaining a loan from a bank or financial institution is generally a cumbersome application and approval process, which commonly involves providing copies of tax returns, filing out many forms, getting an appraisal, responding to the underwriter's questions, etc. In addition, because that type of lender may not be as familiar with property values and improvements as a real estate professional, another burden is placed on the property owner to determine which improvements should be made, to find and select the appropriate service providers, as well as to determine what a reasonable price is. It would be desirable to have a knowledgeable agent coordinate the home improvements and funding thereof. It would be more desirable to avoid financial burden on the seller during the improvement and sales period.

Good real estate agents are familiar with many property-improvement services and service providers that make properties more enticing, whereas the property owner may not be. A real estate agent having this expertise would have a competitive advantage over other real estate agents by providing property improvement services to property owners. Similarly, it would be beneficial to service providers to have a knowledgeable real estate agent promote the property improvement services. It would also be advantageous to the property owner to avoid the financial burden of carrying out the improvements before selling, as well as having a one-stop shopping for the property improvement services.

Therefore, it is an object of this invention to provide a method that marries the real estate listing service with home improvement services. It is another object of this invention is provide a method of improving a home's salability without placing additional financial burden on the seller.

### SUMMARY OF THE INVENTION

The present invention is an improved business method that marries the real estate listing process with property improvement services to enable the property seller to sell an improved property without bearing the costs of the improvement. The real estate professional bears the initial financial burden of providing the home improvement service and is reimbursed by the property seller upon sale of the home or cancellation of the listing.

The preferred embodiment of the method utilizes two agreements: a listing agreement between the property seller and a listing broker and an agreement between the property seller and a home improvement funding source (referred to herein as the “home improvement loan agreement”). The home improvement funding source is the listing agent or a business entity owned, at least in part, by him or her.

A second embodiment utilizes three agreements: the listing agreement between the property seller and the listing broker, an agreement between the property seller and the home improvement funding source, and an agreement between the property seller and the property improvement service provider. Again, the home improvement funding source is the listing agent or a business entity owned by him at least in part.

In a third embodiment, at least one of the property improvement service providers is employed by the home improvement funding source.

In a fourth embodiment, the property improvement service provider has an exclusive contract agreement with the home improvement funding source. The home improvement funding source agrees to promote and use the contracted service provider to perform the designated improvement services and the service provider agrees not to provide such services for other real estate professionals.

### BRIEF DESCRIPTION OF THE DRAWINGS

FIG. 1 is a block diagram that illustrates the general legal relationship of the parties according to the preferred embodiment of the present invention.

FIG. 2 is a block diagram that illustrates a specific example of the legal relationship of the parties according to the preferred embodiment of the present invention.

FIG. 3 is a block diagram that illustrates the legal relationship of the parties according to an alternate embodiment of the present invention.

### DETAILED DESCRIPTION OF THE INVENTION

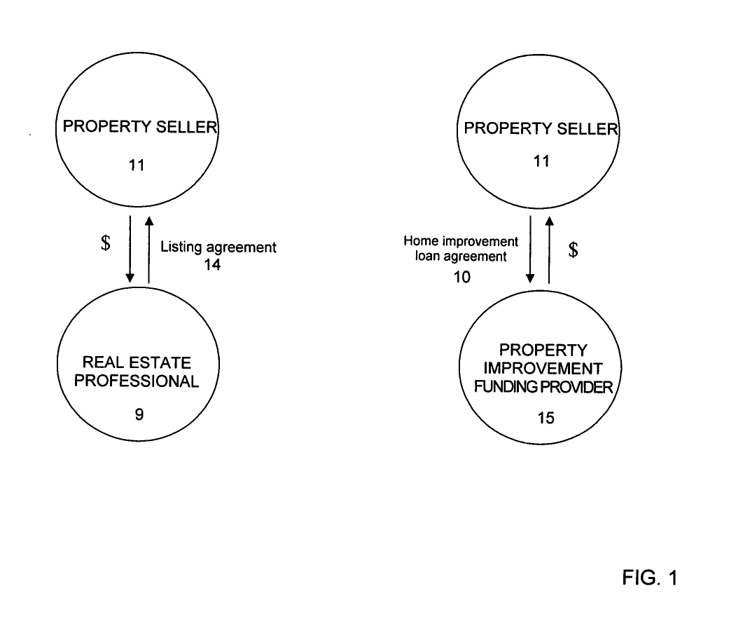

The present invention is a method in which a property seller 11 enters into at least two agreements in order to improve and sell his property without bearing the financial burden of improving it. The agreements are a standard listing agreement 14, as is known in the art, between the property seller 11 and a real estate professional 9 and a home improvement loan agreement 10 between the property seller 11 and a property improvement funding provider 15. The funding provider 15 is the real estate professional 9 or an entity owned, at least in part, by the real estate professional 9. FIG. 1 illustrates the general legal relationship of the parties. The arrows indicate the legal liability to the other. The arrows labeled with the dollar signs point to the party to whom money is paid and the arrows labeled with agreement name point to the party to whom the service is provided. Written agreements are preferred, but oral contracts may suffice if such oral agreements are binding in the applicable jurisdiction. The agreements of the present invention could be combined into a single legal instrument requiring representative signatures from each party.

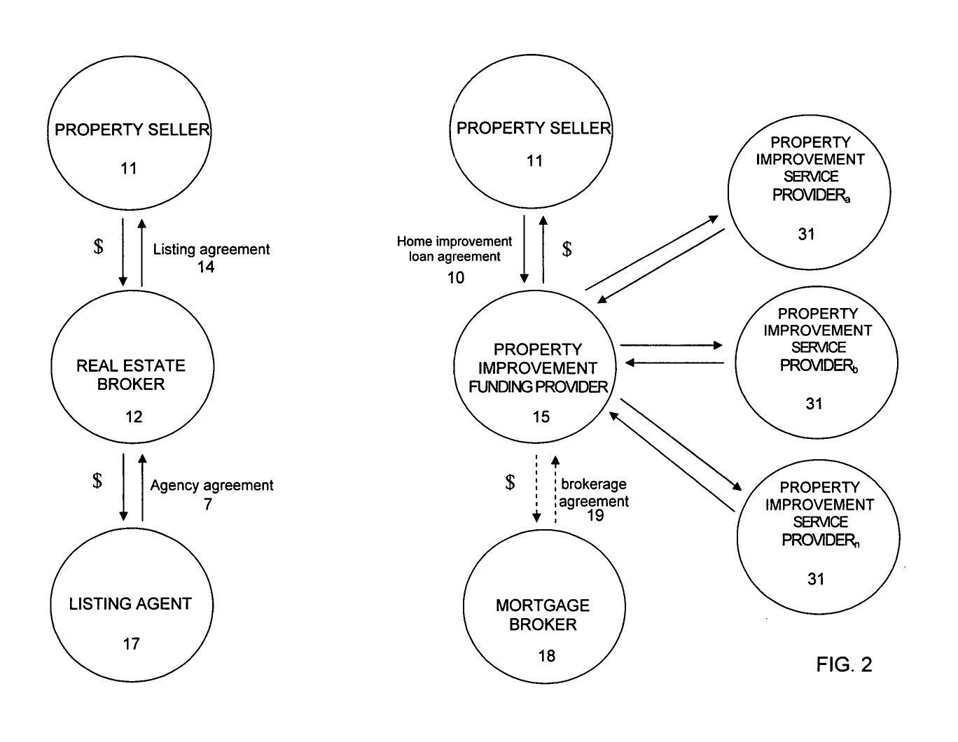

FIG. 2 illustrates a specific example of the legal relationship of the parties in the preferred embodiment. The property seller 11 enters into two primary agreements: the listing agreement 14 and a home improvement loan agreement 10. The listing agreement 14 is between the real estate broker 12 and the property seller 11. The listing agent 17 is specified in the listing agreement 14. Pursuant to an agency agreement 7, the broker 12 will pay to the listing agent 17 a portion of the sales commission received when the property sells.

The home improvement loan agreement 10 is between the property improvement funding provider 15 and the property seller 11. The funding provider 15 is the listing agent 17 or an entity owned at least in part by the listing agent 17. The entity may be informal or formal, such as a partnership, limited liability company, or corporation. The funding provider will provide the necessary funds for the property seller 11 to conduct necessary improvements. The funding provider 15 may also utilize the services of a licensed mortgage broker 19 pursuant to a brokerage agreement 19. This is particularly useful in jurisdictions in which a real estate professional may not collect compensation for rendering services in negotiating mortgage loans unless the real estate professional has a mortgage broker's license or is an employee, officer or partner of a corporation or partnership which holds a mortgage broker license.

Upon execution of the listing agreement 14 and the home improvement loan agreement 10, the funding provider 15 assesses the property's condition and informs the seller 11 of a dollar amount the funding provider 15 is willing to fund for the specific improvements identified in an improvement proposal. Preferably the proposal is provided in writing. The home improvement loan agreement 10 is expressly contingent on the property seller's 11 acceptance of the funding provider's 15 improvement proposal. The home improvement loan agreement 10 gives the property seller 11 a limited time period to accept the improvement proposal. If the property seller 11 does not sign an acceptance of the improvement proposal, the home improvement loan agreement 10 is automatically cancelled, and the property seller 11 would proceed only under the listing agreement 14.

If the property seller 11 signs an acceptance of the improvement proposal, formal loan documents are prepared, typically by a title company. Typically the documents comprise a promissory note and a deed of trust. The initial term of the loan is short, for example 6 months, and the initial interest rate is low, preferably 0% interest to the property seller but typically less than the prime rate. The promissory note may require the property seller 11 to use the loan proceeds solely for those improvements identified in the improvement proposal. The deed of trust is recorded against the subject property in the amount of the loan. The loan will be payable upon successful close of escrow of the property (which constitutes a sale of the property), termination of the listing agreement 14, or at the end of the initial term. The funding provider 15 may extend the initial term of the loan at a minimal interest rate such as prime plus 1%.

The listing agent 17 will suggest one or more property improvement service providers 21 to the property seller 11, but the seller may choose his own property improvement service providers 21. Under appropriate circumstances, considering issues such as ways to improve the property, the interests of the seller, ways to increase the value of the property, etc., service providers may include interior designers, electricians, landscapers, painters, repairmen, floor installers, glazers, masons, carpenters, plumbers, etc. Other service providers include, but aren't limited to, a zoning attorney; an architect; or telephone, sewer, cable, electricity or other utility provider.

The property seller 11 selects one or more property improvement service providers and makes the property available for the work to be performed in a timely manner. The funding provider 15 will hold the loan funds or, alternatively, deposit the loan funds with the title company that prepares the loan documents. The funding provider 15 will do a post-completion inspection of each service provider's 21 work prior to disbursing funds, with the funds being disbursed directly to the property improvement service providers.

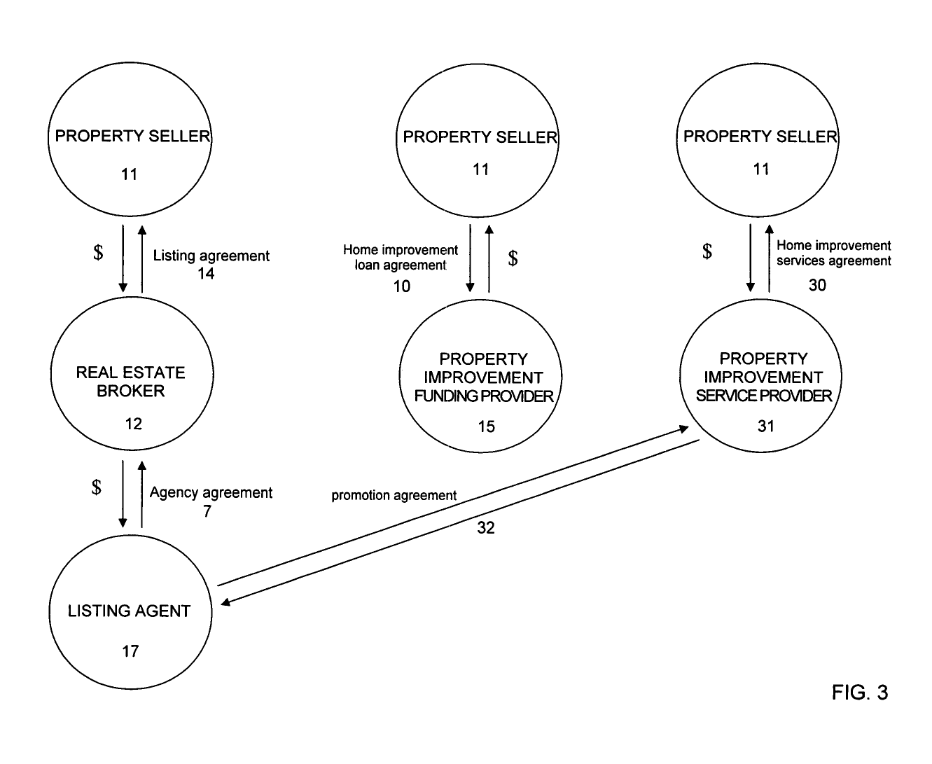

An alternate embodiment adds an express relationship between the listing agent 17 and a property improvement service provider 31. See FIG. 3. The listing agent 17 offers to promote the services of at least one property improvement service provider 31 in exchange for the service provider improving property represented by the listing agent 17. Preferably the agreement is exclusive between the parties, meaning that the listing agent will not promote the services of another service provider of the same service and the service provider will not offer services through another listing agent. If the offer is accepted, a promotion agreement 32 is formed between the listing agent 17 and the home improvement service provider 31. The service provider is paid by the property seller 11 for the improvement services and materials from funds provided by the property improvement funding provider 15. Of course, because the listing agent 17 is, or is a member of, the funding provider 15, the approval of the improvement service provider 31 is automatic.

Before, after, or concurrent with forming the promotion agreement 32 and upon execution of the listing agreement 14 and the home improvement loan agreement 10, the process follows essentially the same steps as of the preferred embodiment. The funding provider 15 assesses the property's condition and informs the seller 11 of an amount the funding provider 15 is willing to fund for the specific improvements identified in an improvement proposal. The home improvement loan agreement 10 is expressly contingent on the property seller's 11 acceptance of the funding provider's 15 improvement proposal. If the property seller 11 does not accept the improvement proposal, the home improvement loan agreement 10 is automatically cancelled.

If the property seller 11 signs an acceptance of the improvement proposal, formal loan documents are prepared. The initial term of the loan is short, for example 6 months and at 0% interest to the property seller. The loan will be payable upon sale of the property, termination of the listing agreement 14, or at the end of the initial term.

The listing agent 17 suggests one or more of the contracted property improvement service providers 21. The property seller 11 selects one or more property improvement service providers and makes the property available for the work to be performed in a timely manner. The funding provider 15 will conduct a post-completion inspection of each service provider's 21 work prior to disbursing funds, with the funds being disbursed directly to the property improvement service providers.

For all embodiments, once the parties are in agreement, the next phase is to ready the property for sale, list it, and sell it. In this phase, the licensing agent lists the seller's property, preferably in the Multiple Listing Service (MLS), as is known in the art. The service provider improves the property, although commonly the actual work is done by a third party, such as an electrician subcontracted to a general contractor. Improvements include the service provided and necessary materials. For example, if the windows need to be updated, the cost will include the cost of the materials and installation thereof. For interior design, the materials may include furniture, art, and other movable property within the home.

The funding provider pays the service provider directly for improvements, sometimes in advance of the work or making payments as work is completed. A certain portion may be held back until the work is completed to satisfaction. The timing of the listing as well as paying for and doing the improvements may vary, depending on the availability of each party and materials, negotiating leverage, and practicalities of getting multiple things done at about the same time. Preferably the property is improved before it is listed, but commonly the property is listed before the improvements are complete.

The sale phase involves the actual sale of the property. The buyer buys the property from the seller and pays the seller for the property. In practice, the money may be paid through a third party, such as the title company. The broker is paid his commission and pays the licensing agent his portion. The funding provider is reimbursed for costs of improvements.

To better illustrate the improved method, an example is provided of the staging and resale of a home. In this example, the owner of a 2500 sq ft. house of traditional architecture decides to sell her home since her children have moved out and she wants to buy a small patio home. The house is in a desirable location, but the decor, while being very stylish when in was first decorated in 1970, is now in need of updating. Taking into account the metallic wallpaper, avocado green kitchen appliances, and other signs of the ‘70’s, the house is appraised at $150 per square foot, giving an appraised value of $375,000. The seller contacts a listing agent familiar with the area who knows that, if decorated and furnished in a more current style, the house would sell for $200 per sq. ft., or $500,000. However, the seller does not have enough cash to pay for the down payment on her patio home and for redecorating the house at the same time. The listing agent and the seller agree that the listing agent will list the house in exchange for a standard 3.5% commission and pay to redecorate the house in exchange for eventual reimbursement for the costs once the house sells.

The listing agent contacts one of the interior designers he knows who agrees to redecorate the house and be paid by the real estate agent. The listing agent introduces the interior designer to the seller. The interior designer and the seller agree that the interior designer will redecorate and furnish the house. Over the next six weeks, the interior designer spends $50,000 decorating the house, paid for by the real estate agent. The listing agent promptly lists and sells the renovated house for $500,000. Of the $500,000 sales price, the agent gets $17,500 in commission and $50,000 reimbursement for the cost of the improvements paid to the interior designer. The standard commission on a $375,000 sale would have been $13,125, so the agent received $4375 more in commission using the present method. The balance of $432,500 goes to the seller, giving her $57,500 more than she would have received less than two months earlier, at no additional financial burden or effort to her. And, the buyer is happy with his redecorated home that he put no effort into.

In another example, the owner of a 2500 sq ft. house of traditional architecture decides to sell his home. The house is in a desirable location, but the house has not been maintained well since it was built and has fallen into a state of sad disrepair; it is in need of complete renovation. Taking into account the need for new electrical wiring, a new roof, new windows and landscaping, the house appraises at $110 per square foot, giving an appraised value of $275,000. The seller contacts a listing agent familiar with the area who knows that, in this area, if the home were completely renovated, including adding a pool and a covered garage, the house would sell for $200 per sq. ft., or $500,000. However, as apparent from its current state, the seller does not have enough knowledge or cash to renovate the home. The listing agent and the seller agree that the listing agent will list the house in exchange for a standard 3.5% commission and will have the listing agent's company pay to have the house renovated for a fee of $150,000 to be reimbursed out of the proceeds of the sale.

The listing agent's company hires a general contractor to renovate the house, including replacing the electrical wiring, roof, and windows and adding a landscaped pool and a covered garage. Over the next three months, the general contractor spends $125,000 renovating the house, paid for by the listing agent's company. The listing agent promptly lists and sells the renovated house for $500,000. Of the $500,000 sales price, the agent gets $17,500 in commission and $150,000 fee for renovation. The standard commission on a $275,000 sale would have been $9625, so the agent received $7885 more in commission using the present method. Since the cost of renovation was $25,000 less than the fee charged, the agent made an additional $25,000 more using this method. The balance of $332,500 sales price goes to the seller, giving him $57,500 more than he would have received less than two months earlier, at no additional financial burden or effort to him. And, again, the buyer is happy with his redecorated home that he put no effort into.

The present invention provides three primary benefits to the sellers: (1) no out-of-pocket expenses; (2) potentially higher net sales proceeds; and (3) potentially faster sale of their properties. The method enables the property seller to sell an improved property without bearing the costs of the improvement. The other parties benefit, too. A service provider benefits because it is provided with more work. A listing agent benefits because the chances of selling the property, and the chances of selling the property sooner and at a higher price, all increase. A broker benefits because the added benefits increase the number of properties listed.

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims.

1. A method of selling property comprising:
a) forming a listing agreement between a real estate professional and a property seller;
b) forming a home improvement loan agreement for a loan between the property seller and a home improvement funding source, wherein the home improvement funding source is the real estate professional;
c) listing the property;
d) improving the property using funds from the home improvement funding source;
e) selling the property to a buyer for a given sum; and
f) distributing the given sum in part to the home improvement funding source as repayment of the loan;
such that the property seller sells an improved property without bearing the costs of the improvement.

2. The method of claim 1 wherein the real estate professional is a real estate brokerage.

3. The method of claim 1 wherein the real estate professional is a real estate broker.

4. The method of claim 1 wherein the real estate professional is a real estate agent.

5. The method of claim 1 wherein the home improvement loan agreement has an initial term and an initial interest rate.

6. The method of claim 5 wherein the loan will be due upon sale of the property, termination of the listing agreement, or at the end of the initial term.

7. The method of claim 5 in which the initial term of the loan is for six months or less.

8. The method of claim 5 in which the initial interest rate of the loan is less than the prime rate.

9. The method of claim 1 further comprising providing an improvement proposal to the property seller from the real estate professional.

10. The method of claim 9 in which the loan comprises a promissory note and a deed of trust and the promissory note requires the property seller to use the loan for improvements identified in the improvement proposal.

11. The method of claim 10 in which the deed of trust is recorded against the property in the amount of the loan.

12. The method of claim 1 wherein the home improvement funding source further comprises a mortgage broker.

13. The method of claim 1 further comprising forming a home improvement services agreement between the property seller and a property improvement service provider.

14. A method of selling property comprising:
a) forming a listing agreement between a real estate broker and a property seller, wherein the listing agreement specifies a listing agent who receives a commission upon the sale of the property;
b) forming a home improvement loan agreement for a loan between the property seller and a home improvement funding source, wherein the home improvement funding source is the listing agent;
c) forming a home improvement services agreement between the property seller and a property improvement service provider;
d) listing the property;
e) improving the property;
f) selling the property to a buyer for a given sum; and
g) distributing the given sum in part to the listing agent for commission and to the home improvement funding source as repayment of the loan;
such that the property seller sells an improved property without bearing the costs of the improvement.

15. The method of claim 14 wherein the home improvement loan agreement has an initial term and an initial interest rate.

16. The method of claim 15 wherein the loan will be due upon sale of the property, termination of the listing agreement, or at the end of the initial term.

17. The method of claim 15 in which the initial term of the loan is for six months or less.

18. The method of claim 15 in which the initial interest rate of the loan is less than the prime rate.

19. The method of claim 14 further comprising providing an improvement proposal to the property seller from the listing agent.

20. The method of claim 19 in which the loan comprises a promissory note and a deed of trust and the promissory note requires the property seller to use the loan for improvements identified in the improvement proposal.

21. The method of claim 20 in which the deed of trust is recorded against the property in the amount of the loan.

22. The method of claim 14 wherein the home improvement funding source further comprises a mortgage broker.

23. The method of claim 14 further comprising forming at least one promotional agreement between the home improvement funding source and at least one property improvement service provider.

24. The method of claim 23 in which the promotional agreement is exclusive.

25. The method of claim 14 in which the property improvement service provider is an interior designer.

26. A method of selling property comprising:
a) forming a listing agreement between a real estate broker and a property seller, wherein the listing agreement specifies a listing agent who receives a commission upon the sale of the property;
b) forming a home improvement loan agreement for a loan between the property seller and a home improvement funding source, wherein the home improvement funding source is an entity owned at least in part by the listing agent;
c) forming a home improvement services agreement between the property seller and a property improvement service provider;
d) listing the property;
e) improving the property;
f) selling the property to a buyer for a given sum; and
g) distributing the given sum in part to the listing agent for commission and to the home improvement funding source as repayment of the loan;
such that the property seller sells an improved property without bearing the costs of the improvement.

27. The method of claim 26 wherein the home improvement loan agreement has an initial term and an initial interest rate.

28. The method of claim 27 wherein the loan will be due upon sale of the property, termination of the listing agreement, or at the end of the initial term.

29. The method of claim 27 in which the initial term of the loan is for six months or less.

30. The method of claim 27 in which the initial interest rate of the loan is less than the prime rate.

31. The method of claim 26 further comprising providing an improvement proposal to the property seller from the listing agent.

32. The method of claim 31 in which the loan comprises a promissory note and a deed of trust and the promissory note requires the property seller to use the loan for improvements identified in the improvement proposal.

33. The method of claim 32 in which the deed of trust is recorded against the property in the amount of the loan.

34. The method of claim 26 wherein the home improvement funding source further comprises a mortgage broker.

35. The method of claim 26 further comprising forming at least one promotional agreement between the home improvement funding source and at least one property improvement service provider.

36. The method of claim 35 in which the promotional agreement is exclusive.

37. The method of claim 35 in which the property improvement service provider is an interior designer.

38. A method of selling property comprising:
a) forming an agreement between a listing agent and at least one property improvement service provider;
b) forming an between a listing agent and a property seller in which the listing agent agrees to bear the costs of improving the property and the property seller agrees to pay the listing agent a commission upon the sale of the property;
c) forming a home improvement loan agreement for a loan between the property seller and a home improvement funding source, wherein the home improvement funding source is an entity owned at least in part by the listing agent;
d) forming an agreement between a property seller and at least one property improvement service provider;
e) listing the property;
f) improving the property;
g) selling the property to a buyer for a given sum; and
h) distributing the given sum in part to the listing agent for the costs of improving the property and for the commission;
such that the property seller sells an improved property without bearing the costs of the improvement.

39. The method of claim 38 wherein the home improvement loan agreement has an initial term and an initial interest rate.

40. The method of claim 39 wherein the loan will be due upon sale of the property, termination of the listing agreement, or at the end of the initial term.

41. The method of claim 39 in which the initial term of the loan is for six months or less.

42. The method of claim 39 in which the initial interest rate of the loan is less than the prime rate.

43. The method of claim 38 further comprising providing an improvement proposal to the property seller from the listing agent.

44. The method of claim 43 in which the loan comprises a promissory note and a deed of trust and the promissory note requires the property seller to use the loan for improvements identified in the improvement proposal.

45. The method of claim 43 in which the deed of trust is recorded against the property in the amount of the loan.

46. The method of claim 38 wherein the home improvement funding source further comprises a mortgage broker.

47. The method of claim 36 further comprising forming at least one promotional agreement between a listing agent and at least one property improvement service provider.

48. The method of claim 47 in which the promotional agreement is exclusive.

49. The method of claim 47 in which the property improvement service provider is an interior designer.
